(19) United States
(12) Patent Application Publication
(10) Pub. No.: US 2004/0047000 A1
(43) Pub. Date: Mar. 11, 2004

(54) Image processing system and image processing method

(75) Inventors: Ryoji Watanabe, Kanagawa (JP); Akihiko Takada, Kanagawa (JP); Masayoshi Sakakibara, Kanagawa (JP); Hajime Kishimoto, Kanagawa (JP); Yasuo Horino, Tokyo (JP); Toshiyuki Yano, Kanagawa (JP); Yasuhiro Matsuo, Kanagawa (JP)

Correspondence Address: OLIFF & BERRIDGE, PLC, P.O. BOX 19928, ALEXANDRIA, VA, 22320, US

(73) Assignee: FUJI XEROX., LTD., Tokyo (JP)

(21) Appl. No.: 10/647,298

(22) Filed: Aug. 26, 2003

(30) Foreign Application Priority Data
Aug. 28, 2002 (JP) P-2002-248790

(51) Int. Cl. G06F 15/00; B41B 1/00; G06K 1/00

(52) U.S. Cl. 358/1.16

(57) ABSTRACT

An image forming apparatus includes an IC chip IF, which is located in the vicinity of an original base where original papers are stored. Under a condition that the original papers are put on the original base, the image forming apparatus reads data from an IC chip attached to one sheet or more sheets of these original papers put on the original base and then, processes image data read from the original paper on the basis of the data read from the IC chip.

The present disclosure relates to the subject matter contained in Japanese Patent Application No.2002-248790 filed on Aug. 28, 2002, which is incorporated herein by reference in its entirety.

### BACKGROUND OF THE INVENTION

1. Field of the Invention

The present invention is related to an image processing system and an image processing method, which can process an image read from an original document by using a non-contact memory attached to the original document.

2. Description of the Related Art

A compact semiconductor chip (for example, u-chip by HITACHI, LTD.) from which an external unit can read stored data in a non-contact manner has been known.

Also, JP-A-2001-229199, JP-A-2000-285203, JP-A-2001-134672, JP-A-2001-283011, JP-A-2001-148000, and JP-A-2001-260580 disclose applications of the compact semiconductor chip.

### SUMMARY OF THE INVENTION

The invention has an object to provide an image processing system and an image processing method, which can perform a data reading operation and a data writing operation, or can execute one of the data reading/writing operations, while utilizing a semiconductor chip from which data stored therein can be read in a non-contact manner.

[Image Processing System]

To achieve the above-described object, according to a first aspect of the invention, an image process system includes an image display member on which an image is displayed, and an image process apparatus. The image display member includes a data storage unit for storing data. The data process apparatus includes a image read unit for reading the displayed image, and a data input/output unit for performing at least one of reading the stored data and writing another data into the data storage unit.

Preferably, the image process apparatus further includes an image process unit for processing the read image on the basis of the read data.

Preferably, the image process apparatus further includes an original accumulation unit for accumulating the image display member, and a transport unit for transporting the accumulated image display member to a position where the displayed image is read. The data input/output unit performs the at least one of reading the data stored in the accumulated image display member and writing another data into the accumulated image display member.

Preferably, when the accumulated image display member is a plurality of image display members, the data input/output unit performs the at least one with respect to the plurality of image display members. Preferably, the image process apparatus further includes a display unit for displaying the read data. When the image display member is accumulated at the original accumulation unit, the data input/output unit performs reading the stored data.

Preferably, the image process apparatus, further includes a transport unit for transporting the accumulated image display member to a position where the displayed image is read. The data input/output unit performs the at least one with respect to the image display member being transported.

Preferably, the image process apparatus further includes a fix unit for fixing the image display member at a position where the displayed image is read. The data input/output unit performs the at least one with respect to the fixed image display member.

Preferably, the data input/output unit starts the at least one under a condition that the image display member is fixed.

[Image Processing Apparatus]

Also, an image process apparatus according to a second aspect of the invention is any one of the image process apparatus in the image process system as described above.

[Image Processing Method]

According to a third aspect of the invention, an image process method includes reading data stored in an image display member, and reading image displayed on the image display member.

Preferably, the method further includes writing another data into the image display member.

[Program]

According to a fourth aspect of the invention, a program makes a computer perform a process including reading data stored in an image display member, and reading image displayed on the image display member.

Preferably, the process further includes writing another data into the image display member.

### BRIEF DESCRIPTION OF THE DRAWINGS

FIG. 1A represents an original paper (image display member) in an exemplification manner whose image is read by a copying apparatus (will be explained later with reference to FIG. 2) in an image processing method according to the present invention; and FIG. 1B indicates a printing paper 42 in an exemplification manner, which is printed by the copying apparatus based upon the original paper exemplified in FIG. 1A.

FIG. 2 is a diagram for indicating a hardware structure of the copying apparatus (image processing apparatus), i.e., for mainly exemplifying a control apparatus thereof.

FIG. 3 is a diagram for exemplifying a hardware construction of a first copying apparatus main body indicated in FIG. 2.

FIG. 4 is a diagram for explaining more in detail a structure of a first original paper feeding apparatus indicated in FIG. 3.

FIG. 5 is a diagram for showing a structure of a first IC chip indicated in FIG. 1A.

FIG. 6 is a diagram for indicating a structure of an IC chip IF shown in FIG. 2, FIG. 3, and FIG. 4.

FIG. 7 is a diagram for showing a structure of an image processing program which is executed by the control apparatus 2 (FIG. 2 and FIG. 3) so as to realize the image processing method according to the present invention.

FIG. 8 is a flow chart for indicating a first operation (step S10) of the copying apparatus (image processing program).

FIG. 9 is a diagram for explaining a structure of a second original feeding apparatus.

FIG. 10 is a flow chart for indicating a second operation (step S11) of a copying apparatus (identifying/printing program).

FIG. 11 is a diagram for explaining an outer appearance of a second copying apparatus main body.

FIG. 12 is a diagram for indicating a cross-sectional view of both a scanner and a platen cover in the case that a platen cover of the second copying apparatus main body shown in FIG. 11 is closed.

FIG. 13 is a flow chart for indicating a third operation (step S14) of a copying apparatus (identifying/printing program).

### DETAILED DESCRIPTION OF THE PREFERRED EMBODIMENT

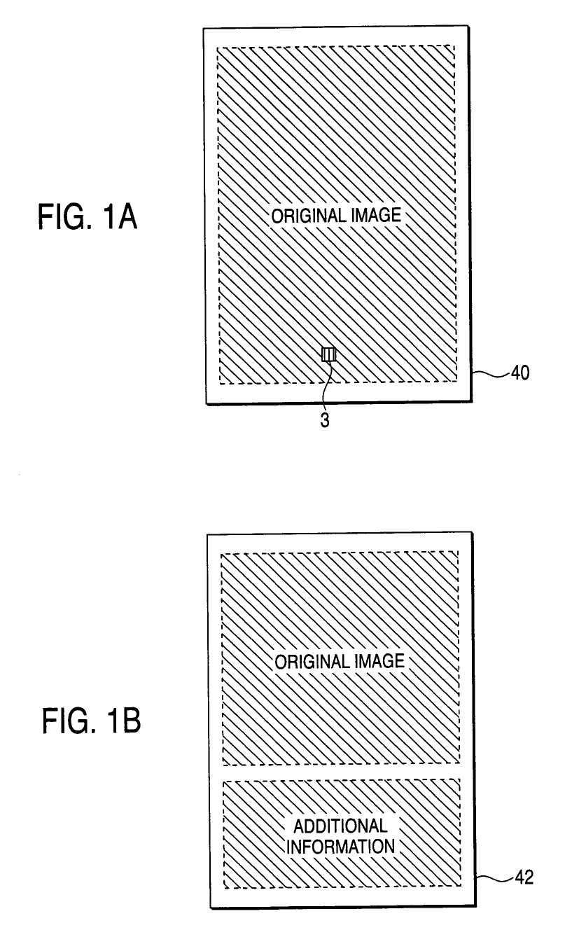

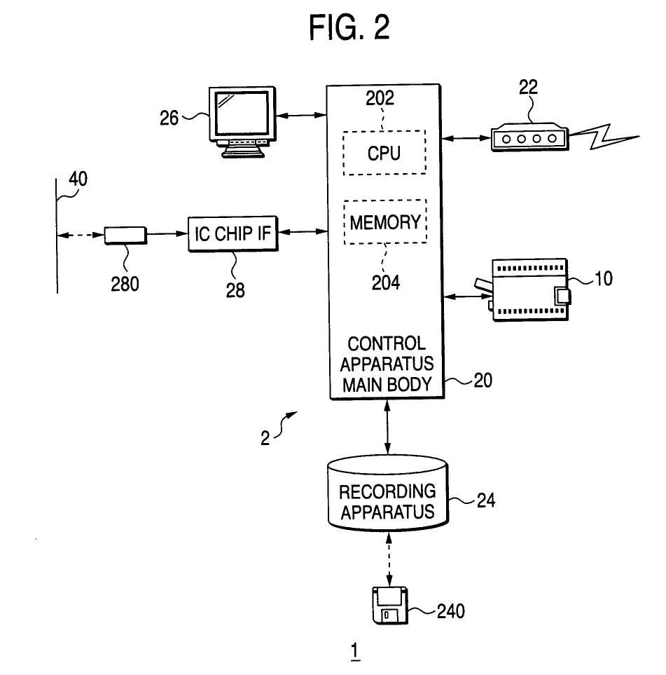

FIG. 1A shows an example of an original paper 40 (image display member), from which a copying apparatus 1 (described later with reference to FIG. 2) reads an image thereon, according to an image processing method of the invention. FIG. 1B shows an example of a printing paper 42, which is printed by the copying apparatus 1 based upon the original paper 40 shown in FIG. 1A.

As shown in FIG. 1A, an original image is displayed on the original paper 40. Furthermore, an IC chip 3 (data storage device) is attached to this original paper 40.

The IC chip 3 is a semiconductor device, which can read therefrom data by using electromagnetic waves in a non-contact manner. This IC chip 3 stores thereinto additional information with respect to information indicated by the original image.

As shown in FIG. 1B, the copying apparatus 1 (described later with reference to FIG. 2) prints an original image read from the original paper 40 shown in FIG. 1A and the additional information read from the IC chip 3 on a printing paper 42.

As described above, in accordance with the image processing method according to the invention, the copying apparatus 1 may form an image by using the image read from the original paper 40 and the additional information read from the IC chip 3 attached to this original paper 40.

[Embodiment]

Various embodiments of an image processing method according to the invention will be described in detail by taking more specific examples.

FIG. 2 is a diagram for showing a hardware structure of the copying apparatus (image processing apparatus) 1, while mainly showing a control apparatus 2 thereof in an exemplification manner.

As shown in FIG. 2, the copying apparatus 1 includes the control apparatus 2 and a first copying apparatus main body 10.

The control apparatus 2 includes a control apparatus main body 20, a communication apparatus 22, a recording apparatus 24 such as an HDD/CD apparatus, a user interface apparatus (UI apparatus) 26, and an IC chip interface (IC chip IF) 28. The control apparatus main body 20 contains a CPU 202, a memory 204, and the like. The user interface apparatus 26 contains either an LCD display apparatus or a CRT display apparatus, and a keyboard/touch panel, and so on. The IC chip interface 28 contains an antenna 280, and corresponds to a data input/output device.

[Copying Apparatus Main Body 10]

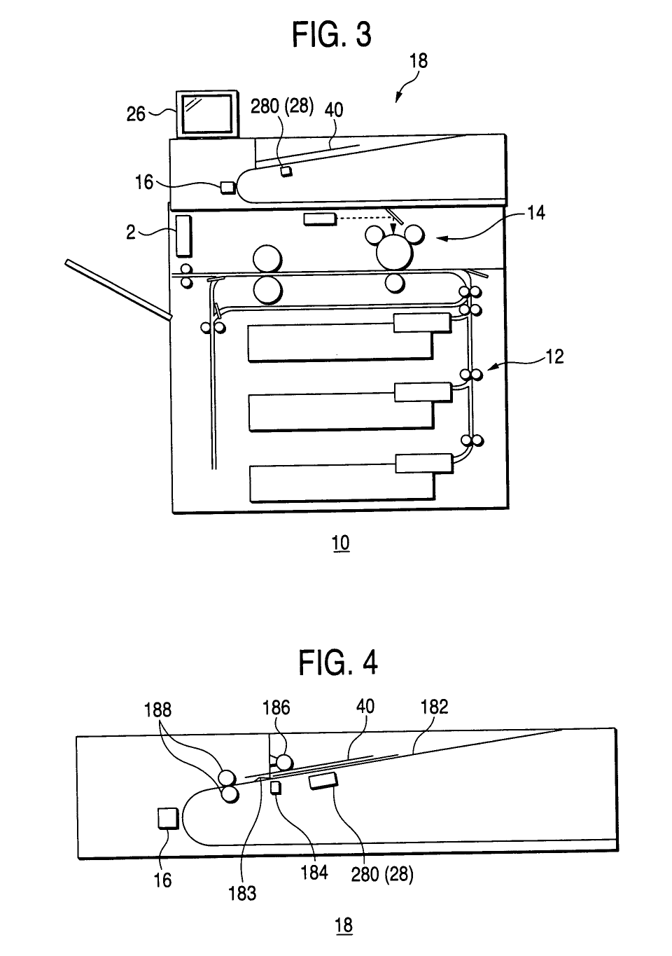

FIG. 3 is a diagram for showing an example of a hardware structure of the first apparatus main body 10 shown in FIG. 2.

As shown in FIG. 3, the apparatus main body 10 includes a paper tray portion 12, a print engine 14, a scanner 16, a first original feeding apparatus 18, and the like. The print engine 14 prints an image on the printing paper 42 (see FIG. 1B) by way of the xerography technique and the like. The scanner 16 reads an image of the original paper 40. The first original feeding apparatus 1-8 feeds the original paper 40.

Also, in the first copying apparatus main body 10, the IC chip IF 28 and the antenna 280 are arranged in the original feeding apparatus 18. Also, the UI (user interface) apparatus 26 is arranged at an upper portion of the copying apparatus main body 10.

In other words, the copying apparatus 1 is realized by employing such a hardware structure that the IC chip IF 28 and the antenna 280 are additionally provided in a general-purpose copying apparatus for reading an image of the original paper 40 fed through the original feeding apparatus 18.

It should be noted that as shown in FIG. 3, the control apparatus 2 (see FIG. 2) is actually stored inside the copying apparatus main body 10.

[Original Feeding Apparatus 18]

FIG. 4 is an explanatory diagram for describing the structure of the first original feeding apparatus 18 shown in FIG. 3 in more detail.

As shown in FIG. 4, this first original feeding apparatus 18 includes an original base 182 (an original accumulation unit), an original retainer 183, an original sensing sensor 184, a paper feed roller 186 (a transport unit), a transport roller 188, and so on. The original base 182 accumulates the original paper 40 (see FIG. 1A). The original retainer 183 retains the accumulated original paper 40. The original sensing sensor 184 senses a fact that the original paper 40 has been accumulated. The paper feed roller 186 feeds the accumulated original paper 40. The transport roller 188 transports the fed original paper 40 to a position of the scanner 16.

The IC chip IF 28 and the antenna 280 are arranged in the close vicinity of a plane where the original paper 40 at the original base 182 is accumulated.

The original base 182 has an inclined surface. The original retainer 183 may retain the original paper 40, which slips down on this inclined surface of the original base 182.

In other words, the original paper 40 is accumulated on the original base 182 in such a manner that one end of this original paper 40 is sorted at the position of the original retainer 183.

The original sensing sensor 184 is arranged in the close proximity of a lower end of the inclined surface of the original base 182, and thus, senses as to whether or not an article is present on the original base 182.

The IC chip IF 28 commences a reading operation of data and a writing operation of data with respect to the IC chip 3 (see FIG. 1A) attached to the original paper 40 under such a condition that the original sensing sensor 184 senses the original paper 40.

The transport roller 186 is arranged in the vicinity of the lower end of the inclined surface of the original base 182, and feeds out a plurality of original papers 40 accumulated on the original base 182 in such a manner that the original papers 40 are sequentially fed out one sheet by one sheet from a top paper thereof by rotating the paper feed roller 186 to the position of the transport roller 188.

The transport roller 188 is arranged in the vicinity of a transport path through which the original paper 40 is transported, and transports the original paper 40 fed out from the original base 182 by rotating the transport roller 188 to a position where the scanner 16 reads the image of this fed original paper 40.

[IC Chip 3/IC Chip IF 28]

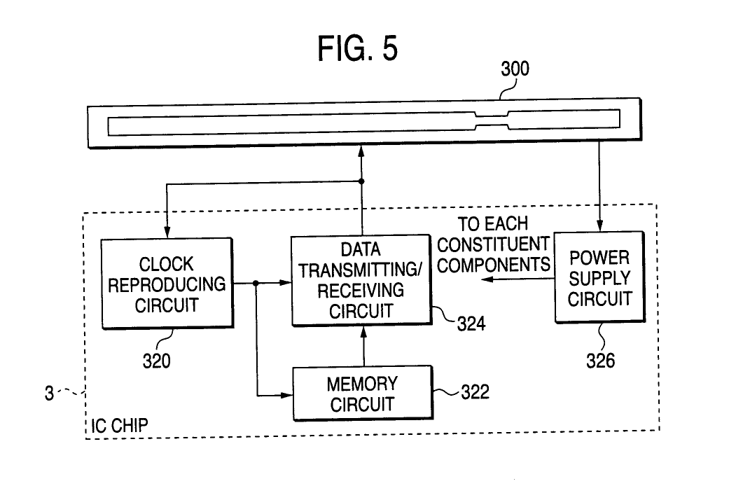

FIG. 5 is a diagram for schematically showing a structure of the first IC chip 3 shown in FIG. 1A.

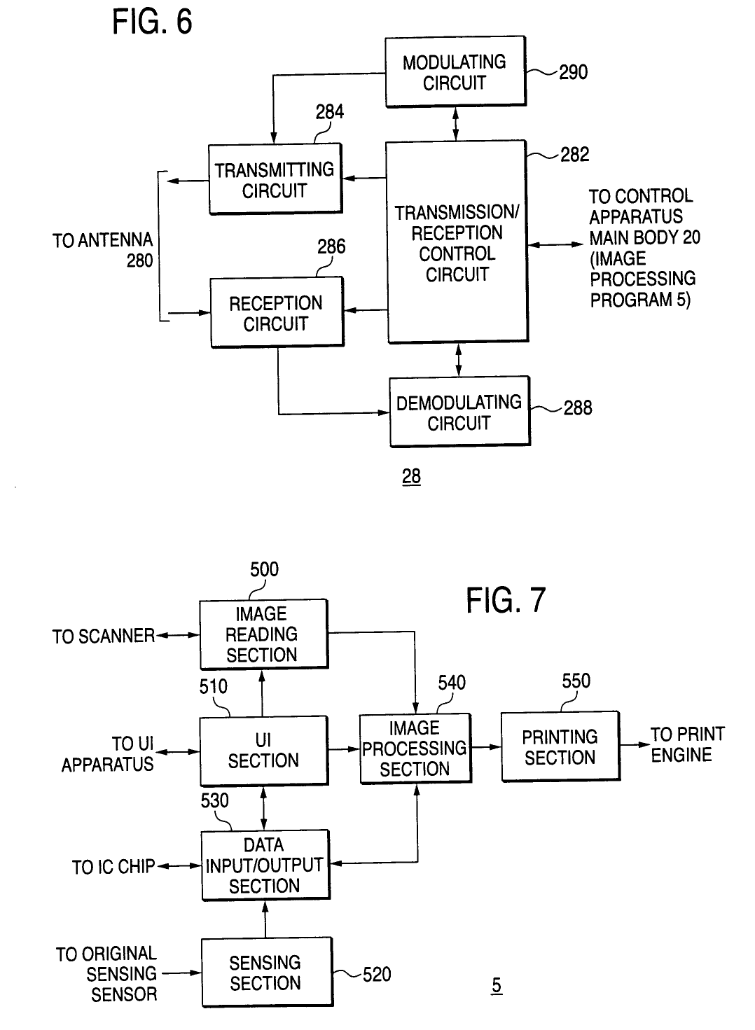

FIG. 6 is a diagram for schematically showing a structure of the IC chip IF 28 shown in FIGS. 2-4.

As shown in FIG. 5, the IC chip 3 includes an antenna 300, a clock reproducing circuit 320, a memory circuit 322, a data transmitting/receiving circuit 324, and a power supply circuit 326.

It should also be noted that when it is so guaranteed that the IC chip 3 of the original paper 40 passes through an area in close proximity to the antenna 280, an IC chip 3 having no antenna 300 may be employed.

Also, as shown in FIG. 6, the IC chip IF 28 includes a transmission circuit 284, a reception circuit 286, a transmission/reception control circuit 282, a demodulation circuit 288, and a modulation circuit 290.

In accordance with the below-mentioned operations of the respective constituent components employed in the IC chip 3 and the IC chip IF 28, information (data) may be written into the IC chip 3 via the IC chip IF 28 in a non-contact manner, and further, information (data), which has been stored in the IC chip 3, may be read therefrom via the IC chip IF 28 in a non-contact manner.

In the IC chip 3 (see FIG. 5), the power supply circuit 326 rectifies an electromagnetic wave signal supplied via the antenna 300 so as to supply electric power to the respective constituent components of the IC chip 3, while this electric power is required for these constituent components.

The clock reproducing circuit 320 reproduces a clock signal from the electromagnetic wave signal supplied via the antenna 300 from the IC chip IF 28 and then, outputs this reproduced clock signal to the memory circuit 322 and the data transmitting/receiving circuit 324.

The memory circuit 324 is, for example, a nonvolatile RAM (random access memory). This memory circuit 324 stores thereinto data indicating information, which is input from the data transmitting/receiving circuit 324 in synchronism with the clock signal input from the clock reproducing circuit 320.

Also, the memory circuit 322 outputs data indicating information stored therein to the data transmitting/receiving circuit 324 in synchronism with the clock signal.

To clarify and embody contents of explanations, in this embodiment, the following case is taken as a specific example. That is, the additional information has been stored in the memory circuit 322 at a stage that the IC chip 3 is attached to the original paper 40.

The data transmitting/receiving circuit 324 demodulates the electromagnetic wave signal input via the antenna 300 into data and then, outputs the demodulated data to the memory circuit 322 in synchronism with the clock signal input from the clock reproducing circuit 320.

Also, the data transmitting/receiving circuit 324 changes a reflection intensity of the electromagnetic wave signal supplied from the IC chip IF 28 in accordance with a value of the data input from the memory circuit 322 in synchronism with the clock signal.

As described above, the data indicating the information, which has been stored in the memory circuit 322, is transmitted from the IC chip 3 to the IC chip IF 28 by changing the intensity of the reflection signal of the electromagnetic wave signal transmitted from the IC chip IF 28 to the IC chip 3.

In the IC chip IF 28 (FIG. 6), the transmission/reception control circuit 282 controls operations of the respective constituent components of this IC chip IF 28.

Also, this transmission/reception control circuit 282 outputs data input from the control apparatus main body 20 (namely, image processing program 5, which will be described later with reference to FIG. 7) to the demodulation circuit 288.

Further, this transmission/reception control circuit 282 outputs data, which has been received by the reception circuit 286 and then has been demodulated by the demodulation circuit 288, to the control apparatus main body 20.

The modulation circuit 290 modulates a high frequency signal (radio frequency signal) based upon data input from the transmission/reception control circuit 282 to produce an electromagnetic wave signal and then, outputs this produced electromagnetic wave signal to the transmission circuit 284.

The transmission circuit 284 transmits via the antenna 280 to the IC chip 3 the electromagnetic wave signal containing the data to be stored in the IC chip 3 and the clock signal.

The reception circuit 296 receives the reflection signal, which is reflected from the IC chip 3, and then outputs this received reflection signal to the demodulation circuit 288.

The demodulation circuit 288 demodulates the data transmitted from the IC chip 3 based upon a change of the reflection signal input from the reception circuit 286, and then outputs the demodulated data to the transmission/reception control circuit 282′.

[Image Processing Program 5]

FIG. 7 is a block diagram for schematically showing a structure of the image processing program 5, which is executed by the control apparatus 2 (see FIG. 2 and FIG. 3) so as to realize the image processing method according to the invention.

As shown in FIG. 7, the image processing program 5 includes an image reading section 500, an UI section 502, a sensing section 520, a data input/output section 530, an image processing section 540, and a printing section 550.

The image processing program 5 prints an image by using an image read from the original paper 40 and data read from the IC chip 3.

The image processing program 5 is supplied via, for example, a recording medium 240 (see FIG. 2) to the control apparatus 2, and is loaded to the memory 204 so as to be executed.

In the image processing program 5, the image reading section 500 controls the constituent component of the copying apparatus main body 10 such as the scanner 16 (FIGS. 3 and 4) and the original feeding apparatus 18 (FIGS. 3 and 4) to read an original image of the transported original paper 40 (FIG. 1A).

The UI section 502 receives operation by a user with respect to the UI apparatus 26 (FIG. 2 and FIG. 3), and outputs data indicating starting of a printing operation to the image processing section 540.

Also, the UI section 510 displays the additional information read from the IC chip 3 on the UI apparatus 26.

The sensing section. 520 controls the original sensing sensor 184 (FIG. 4) so as to sense that the original paper 40 has been accumulated on the original base 182.

When the original paper 40 is sensed, the sensing section 520 instructs the data input/output section 530 to read the data.

When the sensing section 520 senses the original paper 40, the data input/output section 530 controls the IC chip IF 28 (FIG. 4) so as to read data of additional information from the IC chip 3 (FIG. 1A) attached to the original paper 40.

Also, in such a case that two sheets or more sheets of the original papers 40 are mounted on the original base 184 (FIG. 4), the data input/output section 530 read the data of the additional information from the IC chips 3, which are attached to two sheets or more sheets of the original papers 40, respectively.

The image processing section 540 synthesizes the data of the original image received from the image reading section 500 with the data of the additional information received from the data input/output section 530 and then, outputs the synthesized data to the printing section 550.

The printing section 550 controls the print engine. 14′ (FIG. 3) and the like so as to print the synthesized data, which is input from the image processing section 540, on the printing paper 42 (FIG. 1B).

[Overall Operation]

Next, overall operation of the copying apparatus 1 is described.

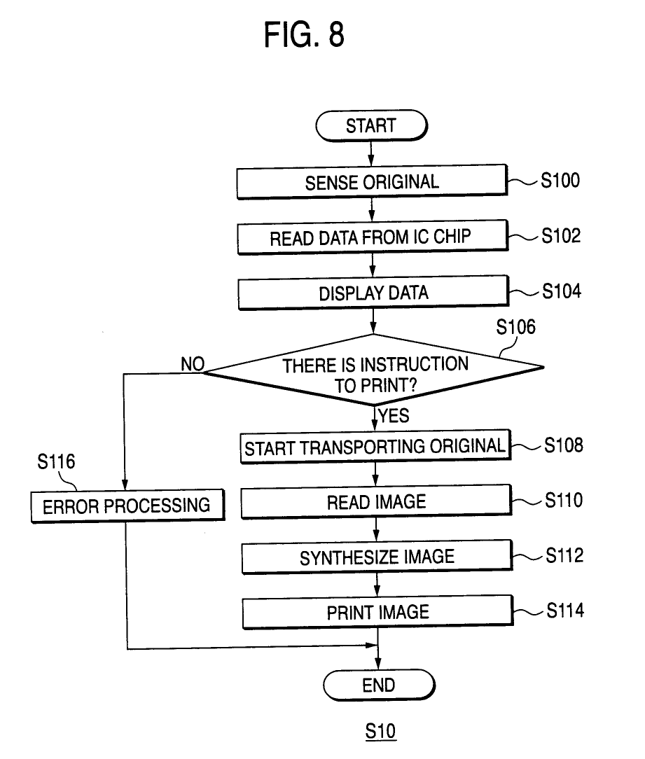

FIG. 8 is a flow chart for describing a first operation (S10) of the copying apparatus 1 (namely, image processing program 5).

As shown in FIG. 8, in a step 100 (S100), when the user puts the original paper 40 on the original base 182 (FIG. 4), the sensing section 520 (FIG. 7) controls the original sensing sensor 184 (FIG. 4) so as to sense a fact that the original paper 40 is putted on the original base 182, and outputs information indicating that the original paper 40 is putted to the data input/output section 530.

In a step 102 (S102), when the data input/output section 530 (FIG. 7) receives the information indicating that the original paper 40 is putted on the original base 182, the data input/output section 530. (FIG. 7) controls the IC chip IF 28 (FIG. 4) so as to read the data of the additional information from the IC chip 3 of the original paper 40 accumulated in the original base 182 (FIG. 4).

It should be understood that when two sheets or more sheets of the original papers 40 are putted on the original base 184, the data input/output section 530 simultaneously reads the data of the addition information from the respective IC chips 3, which are attached to two sheets or more sheets of the original papers 40.

In a step 104 (S104), the UI section 510 (FIG. 7) controls the UI apparatus 26 (FIGS. 2 and 3) to display the additional information read from the IC chip 3.

The user confirms the additional information displayed on the UI apparatus 26, and may rewrite the additional information stored in the IC chip 3 by operating the UI apparatus 26, if required.

In a step 106 (S106), the UI section 510 (FIG. 7) receives an operation that the user instructs a printing operation via the UI apparatus 26 (FIGS. 2 and 3), for a predetermined time period.

When the operation for instructing the printing operation is received within a predetermined time period, the image processing program 5 is advanced to a process operation of a step S108, whereas in other cases, this image processing program 5 is advanced to another process operation of a step S116.

In the step 108 (S108), the image reading section 500 (FIG. 7) controls the original feeding apparatus (FIGS. 3 and 4) so as to commence the transport operation of the original paper 40 accumulated in the original base 182 (FIG. 4).

In a step 110 (S110), the image reading section 500 controls the scanner 16 (FIGS. 3 and 4) to read an original image from the original image 40 transported by the original feeding apparatus 18.

In a step 112 (S112), the image processing section 540 (FIG. 7) synthesizes the data of the original image input from the image reading section 500 with the data of the additional information input from the data reading unit 520 to obtain synthesized image data and then, outputs this synthesized image data to the printing section 540.

In a step 114 (step S114), the printing section 550 (FIG. 7) controls the print engine 14 (FIG. 3) and the like so as to print the image data input from the image processing section 540.

In a step 116 (step S116), the image processing program 5 executes an error processing operation.

As an example of this error processing operation, the UI apparatus 26 displays a message indicating that since the printing process operation is not instructed to the copying apparatus 1 (FIG. 2) for the predetermined period, an operation mode is switched to a power save mode. Then, the image processing program 5 initializes the process operation.

As described above, the copying apparatus 1 reads the additional information from the IC chip 3 attached to the original paper 40 by using the IC chip IF 28 and the antenna 280, which are arranged on the original base 182, and then, can execute the printing process operation by using the read additional information.

[Modification 1]

It should also be noted that both the IC chip IF 28 and the antenna 280, which are shown in FIG. 4, may be alternatively arranged in the vicinity of a transport path through which the original paper 40 is transported.

The IC chip IF 28 of the modification 1 executes a data reading operation and a data writing operation with respect to the IC chip 3 of the original paper 40, which is transported through this transport path.

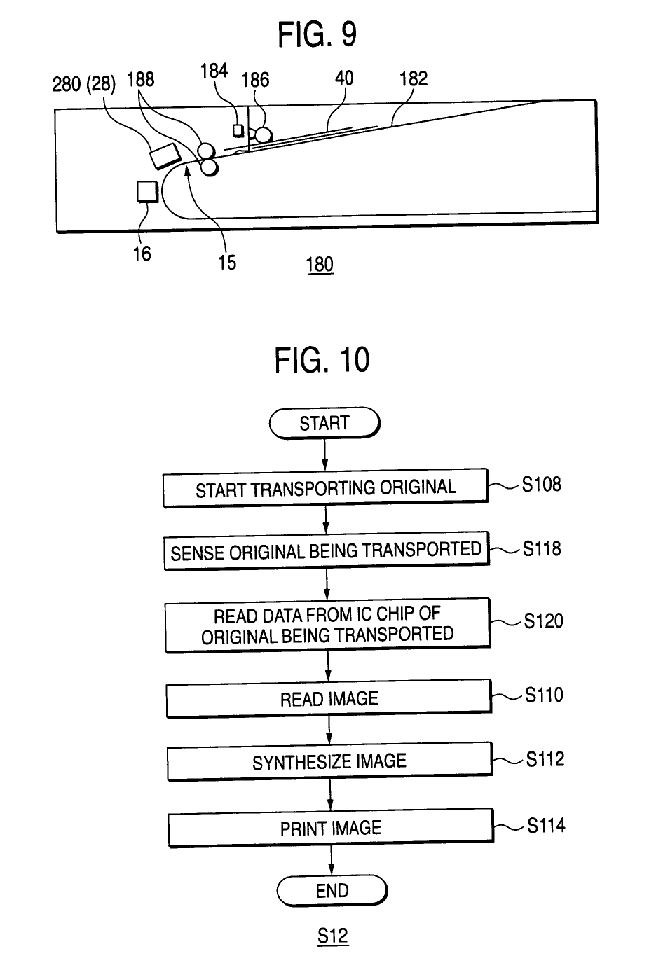

FIG. 9 is an explanatory diagram for showing a structure of a second original feeding apparatus 180.

As shown in FIG. 9, in the second original feeding apparatus 180, the IC chip IF 28 and the antenna 280 are arranged in the vicinity of a transport path 15 through which the original paper 40 fed out from the original base 182 is transported.

In other words, the IC chip IF 28 used in this second original feeding apparatus 180 executes a data reading operation and a data writing operation with respect to the IC chip 3 of the original paper 40, which is sequentially transported through this transport path 15.

It should be noted that the same reference numerals will be allotted to constituent components of the second original feeding apparatus 180, which is substantially same as those of the first original feeding apparatus 18.

The original sensing sensor 184 is arranged in the vicinity of the transport path 15, and senses as to whether or not the original paper 40 transported through the transport path 15 is present.

The IC chip IF 28 commences the data reading operation and the data writing operation with respect to the IC chip 3 (FIG. 1A) attached to the original paper 40 under such a condition that the original sensing sensor 184 senses the original paper 40.

FIG. 10 is a flow chart for describing a second operation (step S12) of the copying apparatus 1 (image processing program 5).

It should also be understood that of the operation processes shown in FIG. 10, the same reference numeral is allotted to an operation process, which is the same as that shown in FIG. 8.

In the second operation of the copying apparatus 1, when the user instructs the UI apparatus (FIGS. 2 and 3) to execute a printing operation in a step 108 (S108), the UI section 510 (FIG. 7) instructs the image reading section 500 so as to transport an original paper 40 and read an image of this original paper 40.

The image reading section 500 controls the second original feeding apparatus 180 to feed out the original paper 40 putted on the original base 182 (FIG. 9) to the transport path 15 one sheet by one sheet.

when the sensing section 520 (FIG. 7) controls the original sensing sensor 184 (FIG. 9) so as to sense the transported original paper 40 in a process operation of a step 118 (S118), the data input/output section 530 reads data of additional information from the IC chip 3 of the transported original paper 40 in a process operation of a step 120 (S120).

When the original image is read from the transported original paper 40 in S110, the image processing section 540 (FIG. 7) synthesizes the data of the original image and the data of the additional information, which are read from the same original paper 40 in S112.

Accordingly, when the IC chip IF 28 and the antenna 280 are arranged in the vicinity of the transport path 15, since the copying apparatus 1 can perform the data reading operation and the data writing operation every time the original paper 40 is transported, either the read data or the data to be written can be associated with the respective original papers 40.

[Modification 2]

Alternatively, the IC chip IF 28 and the antenna 280, which are shown in FIG. 4, may be arranged in a platen cover, which covers the original paper 40.

The IC chip IF 28 and the antenna 280 perform a data reading operation and a data writing operation, when the original paper 40 is covered by this platen cover in this modification 2.

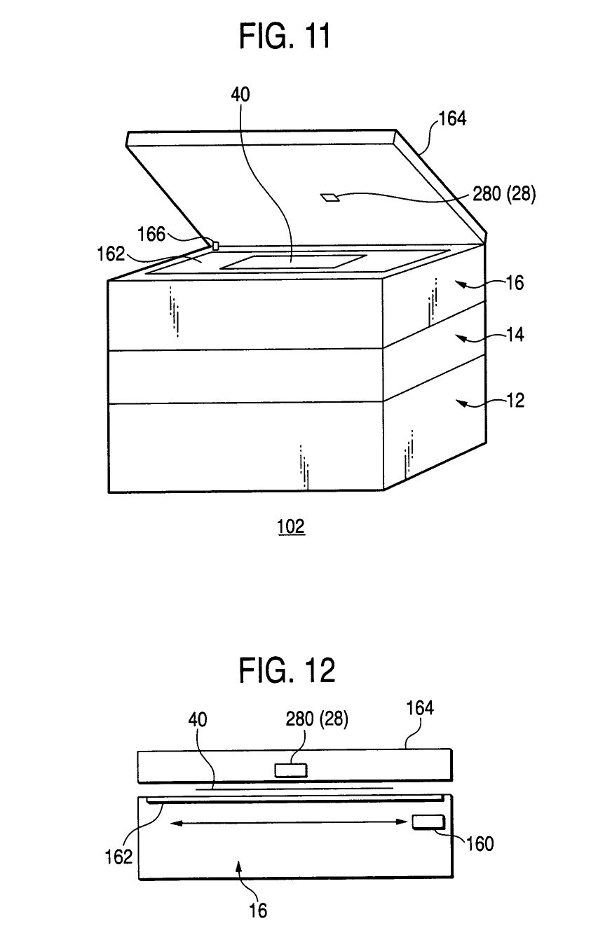

FIG. 11 is a diagram for illustratively showing an outer view of a second copying apparatus main body 102.

As shown in FIG. 11, a platen glass 162 and an open/close sensor 166 are arranged on an upper surface of a housing of the scanner 16 in the second copying apparatus main body 102. Further, a platen cover 164 (fixing unit) is provided with this second copying apparatus main body 102. The platen cover 164 is connected to an edge portion of the upper surface of the housing of the scanner 16.

It should also be noted that the same reference numerals will be allotted to constituent components of the second copying apparatus main body 102, which is substantially same as those of the copying apparatus main body 10.

The edge portion of the platen cover 164 is connected via a hinge to the edge portion of the housing of the scanner 16. The platen cover 164 may be closed in such a manner that this platen cover 164 covers the upper surface of the housing of the scanner 16, and also, may be opened in such a manner that this platen cover 164 is detached from the upper surface of the housing of the scanner 16.

This platen cover 164 contains the IC chip IF 28 and the antenna 280 in the vicinity of a plane thereof, which is engaged with the upper surface of the housing of the scanner 16 in the case that the platen cover 164 is closed.

When the image of the original paper 40 is read, the platen cover 164 is closed, and the platen glass 162 and the platen cover 164 sandwich the original paper 40 so as to fix this-original paper 40.

The open/close sensor 166 senses open/close conditions of the platen cover 164.

FIG. 12 is a cross-sectional diagram for showing the scanner 16 and the platen cover 164 in the case that the platen cover 164 of the copying apparatus main body 102 shown in FIG. 11 is closed.

As shown in FIG. 12, a scanner head 160 capable of reading images is provided inside the housing of the scanner 16.

The platen glass 162 is made of a transparent plate such as a glass, and may penetrate therethrough reflection light, which is reflected from the original paper 40 putted on this platen glass 162.

In this case, while the scanner head 160 is moved along an arrow direction, this scanner head 160 reads an image from the original paper 40 and then reads an entire original image displayed on the original paper 40.

When the platen cover 164 is engaged with the original paper 40 as shown in FIG. 12, the IC chip IF 28 performs a data reading operation and a data writing operation with respect to the IC chip 3 attached to this original paper 40.

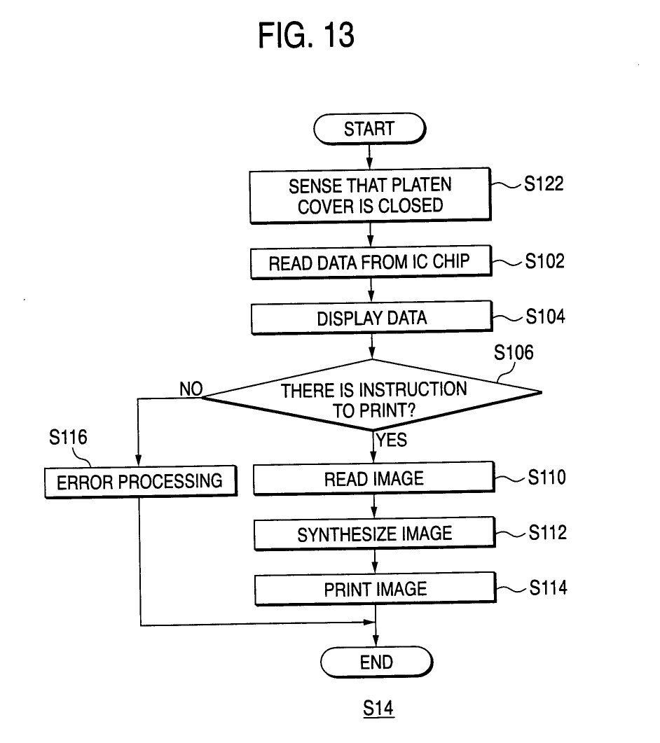

FIG. 13 is a flow chart for describing a third operation (step S14) of the copying apparatus 1 (image processing program 5).

It should also be understood that the same reference numeral will be allotted to a process operation shown in FIG. 13, which is substantially same as that shown in FIG. 8.

As shown in FIG. 13, in the third operation of the copying apparatus 1, in a process operation of a step 122 (S122), when the user puts the original paper 40 on the platen glass 162 (FIGS. 11 and 12) and then closes the platen cover 164 (FIG. 11 and FIG. 12), the sensing section 520 (FIG. 7) controls the open/close sensor 166 (FIGS. 11 and 12) so as to sense a fact that the platen cover 164 is closed.

When the sensing section 520 senses that the platen cover 164 is actually closed, this sensing section 520 instructs the data input/output section 530 to execute a data reading operation.

In other words, when the platen cover 164 is closed, the data input/output section 530 controls the IC chip IF 28 so as to start a reading operation of the data from the IC chip 3.

Also, the data input/output section 530 controls the IC chip IF 28 so as to execute a data writing operation with respect to the IC chip 3 under such a condition that the platen cover 164 is closed.

Accordingly, an arrangement that both the IC chip IF 28 and the antenna 280 are provided with the platen cover 164 may become suitable in such a case that the user opens/closes the platen cover 164 and manually sets the original document 40 to the image reading position.

As described above, in accordance with the image processing system and the image processing method of the invention, the images can be processed by using a semiconductor chip from which the data stored thereinto is read in the non-contact manner.

FIG. 5

320 clock reproducing circuit

322 memory circuit

324 data transmitting circuit

326 power supply circuit

FIG. 6

282 transmission/reception control circuit

284 transmitting circuit

286 reception circuit

288 demodulating circuit

290 modulating circuit

FIG. 7

500 image reading section

510 UI section

520 sensing section

530 data input/output section

540 image processing section

550 printing section

FIG. 8

S100 sense original

S102 read data from IC chip

S104 display data

S106 is there instruction to print?

S108 start transporting original

S110 read image

S112 synthesize image

S114 print image

S116 error processing

FIG. 10

S108 start transporting original

S110 read image

S112 synthesize image

S114 print image

S118 sense original being transported

S120 read data from IC chip of original being transported

FIG. 13

S102 read data from IC chip

S104 display data

S106 is there instruction to print?

S110 read image

S112 synthesize image

S114 print image

S116 error processing

S122 sense that platen cover is closed

What is claimed is:

1. An image process system comprising:
an image display member on which an image is displayed; and
an image process apparatus, wherein:
the image display member includes a data storage unit for storing data; and
the data process apparatus includes:
a image read unit for reading the displayed image; and
a data input/output unit for performing at least one of reading the stored data and writing another data into the data storage unit.

2. An image process apparatus comprising:
a image read unit for reading an image displayed on an image display member; and
a data input/output unit for performing at least one of reading data stored in the image display member and writing another data into the image display member.

3. The image process apparatus according to claim 2, further comprising:
an image process unit for processing the read image on the basis of the read data.

4. The image process apparatus according to claim 2, further comprising:
an original accumulation unit for accumulating the image display member; and
a transport unit for transporting the accumulated image display member to a position where the displayed image is read, wherein:
the data input/output unit performs the at least one of reading the data stored in the accumulated image display member and writing another data into the accumulated image display member.

5. The image process apparatus according to claim 4, wherein when the accumulated image display member is a plurality of image display members, the data input/output unit performs the at least one with respect to the plurality of image display members.

6. The image process apparatus according to claim 4, further comprising:
a display unit for displaying the read data, wherein:
when the image display member is accumulated at the original accumulation unit, the data input/output unit performs reading the stored data.

7. The image process apparatus according to claim 2, further comprising:
a transport unit for transporting the accumulated image display member to a position where the displayed image is read, wherein:
the data input/output unit performs the at least one with respect to the image display member being transported.

8. The image process apparatus according to claim 2, further comprising:
a fix unit for fixing the image display member at a position where the displayed image is read, wherein:
the data input/output unit performs the at least one with respect to the fixed image display member.

9. An image process method comprising:
reading data stored in an image display member; and
reading image displayed on the image display member.

10. The image process method according to claim 9, further comprising:
writing another data into the image display member.

11. A program making a computer perform a process comprising:
reading data stored in an image display member; and
reading image displayed on the image display member.

12. The program according to claim 11, wherein the process further includes:
writing another data into the image display member.
